(19) United States
(12) Patent Application Publication
(10) Pub. No.: US 2009/0200801 A1
(43) Pub. Date: Aug. 13, 2009

(54) DUCT AND THE MANUFACTURING METHOD

(75) Inventors: Toshikazu HASEGAWA, Kounosu-shi (JP); Isamu KAJINO, Kounosu-shi (JP)

Correspondence Address: ARENT FOX LLP, 1050 CONNECTICUT AVENUE, N.W., SUITE 400, WASHINGTON, DC, 20036, US

(73) Assignee: SHINFUJI KUUCHOU CO., LTD., Kounosu-shi (JP)

(21) Appl. No.: 12/028,456

(22) Filed: Feb. 8, 2008

(51) Int. Cl. F16L 23/00

(52) U.S. Cl. 285/407

(57) ABSTRACT

A duct is provided which there is no need to attach any reinforcing material to. This duct has a hollow 5 formed by joining a plurality of flat wall plates 11 to 14 so that the interior surfaces of the wall plates 11 to 14 face each other. The duct is provided with four folded portions including a strip-shaped folded portion 11C, 12C formed by folding each wall plate 11 to 14 on the side of the exterior surface of each wall plate 11 to 14.

### BACKGROUND OF THE INVENTION

1. Field of the Invention

The present invention relates to a duct for sending air or the like whose temperature is regulated, and a manufacturing method for the same.

2. Description of the Related Art

A plurality of ducts are provided on the inside of a structure, for example, inside of the ceiling of a building, so that an air-flow path can be formed, through which air or the like flows after its temperature is regulated. Such a duct is shaped like a box which is manufactured by cutting or bending an iron plate. When a duct is produced, for example, as shown in FIG. 26, both long-side edges of each iron plate 101 to 104 are each folded to form a junction portion. Then, both short-side edges of each iron plate 101 to 104 are bent to form each bent portion 101A to 104A. Next, using the junction portion, each iron plate 101 to 104 is connected, and this connected part is double-seamed. Thus, the iron plates 101 to 104 make up a rectangular box body. Thereafter, a corner metal fitting 105 is attached to each corner part of each bent portion 101A to 104A to form a flange, thereby resulting in a duct 100. In the duct 100, in order to reinforce each iron plate 101 to 104, an L-shaped reinforcing material 110 (i.e., angle steel) may be respectively attached parallel to and a predetermined distance away from the flange, over the full periphery of the duct 100 (e.g., refer to Japanese Patent Laid-Open No. 2004-3821 specification).

In a similar manner, ducts having various shapes are created, and such ducts are combined to form a passage for sending air or the like.

However, the above described duct 100 has the following disadvantages. When each reinforcing material 110 is attached to the duct 100, as shown in FIG. 27, in each predetermined position 111 of the reinforcing material 110, it is joined by spot welding or a rivet.

In the case of spot welding, the reinforcing material 110 is positioned on each iron plate 101 to 104, and in this state, the spot welding is conducted. This can increase the numbers of working processes and component parts when the duct 100 is manufactured. Besides, the reinforcing material 110 is an angle steel, and thus, the duct 100 can be heavier.

In the case of the junction by means of a rivet, as shown in FIG. 28a, the reinforcing material 110 is positioned on the iron plate 101 so that they can be joined together with a rivet 120. Next, as shown in FIG. 28b, the rivet 120 is driven into the reinforcing material 110 and the iron plate 101. Then, as shown in FIG. 28c, the rivet 120′ tip is caulked (pressed). When the junction is conducted by means of a rivet, in the same way as spot welding, the reinforcing material 110 is positioned on each iron plate 101 to 104 and is subjected to the spot welding with kept positioned. This raises disadvantages in that the numbers of working processes and component parts will increase in the duct 100's production, as well as the duct 100 will be heavier. Besides, in the process of attaching the reinforcing material 110, the rivet 120 is driven and caulked. Such a working process can make a loud noise. In addition, if the rivet 120 is incompletely caulked, air may pass from a hole in the part where the rivet 120 is driven. This makes it impossible to maintain the airtightness of the duct 100.

### SUMMARY OF THE INVENTION

In order to resolve the above described disadvantages, it is an object of the present invention to provide a duct to which there is no need to attach any reinforcing material, and a manufacturing method for this duct.

In order to resolve those disadvantages, a duct according to a first aspect of the present invention which has a hollow (air flow path) formed by joining a plurality of flat wall plates so that the interior surfaces of the wall plates face each other, wherein each of the wall plates includes a strip-shaped folded portion formed by folding each wall plate on the side of the exterior surface thereof.

According to the first aspect of the present invention, the folded portion is formed on the side of the exterior surface of each wall plate, so that a reinforcing portion can be provided outside of the duct.

A duct according to a second aspect of the present invention which has a hollow formed by joining a plurality of flat wall plates so that the interior surfaces of the wall plates face each other, wherein each of the wall plates includes a strip-shaped folded portion formed by folding each wall plate on the side of the interior surface thereof.

According to the second aspect of the present invention, the folded portion is formed on the side of the interior surface of each wall plate, so that a reinforcing portion can be provided inside of the duct.

A duct according to a third aspect of the present invention, in the duct according to the first or second aspect, wherein the folded portion is formed in the directions where the hollow is formed, or in the directions which intersect the directions where the hollow is formed.

According to the third aspect of the present invention, the folded portion is formed in the directions where the hollow is formed, or in the directions which intersect the directions where the hollow is formed.

A duct according to a fourth aspect of the present invention, in the duct according to the third aspect, wherein: the folded portion in each wall plate is formed in the directions which intersect the directions where the hollow is formed; and a connecting metal fitting is provided which connects an end of each folded portion and the end of the folded portion adjacent to this end.

According to the fourth aspect of the present invention, each folded portion is connected by means of the connecting metal fitting, so that a reinforcing portion can be formed over the whole exterior circumference or the whole interior circumference of the duct.

A duct according to a fifth aspect of the present invention, in the duct according to the second aspect, wherein in each of the wall plates which face each other, the folded portion is formed in the directions where the hollow is formed.

A duct according to a sixth aspect of the present invention, in the duct according to the fifth aspect, wherein a reinforcing member is provided which reinforces the wall plates by connecting each folded portion.

According to the sixth aspect of the present invention, the folded portions are connected by means of the reinforcing member. Therefore, the wall plates which face each other are connected so that the wall plates can be reinforced.

A duct according to a seventh aspect of the present invention, in the duct according to the first or second aspect, wherein a packing is provided so as to be sandwiched in the folded portion.

A duct manufacturing method according to an eighth aspect of the present invention in which a hollow is formed by joining a plurality of flat wall plates, comprising the steps of: forming a strip-shaped folded portion by folding each wall plate in the exterior surface thereof; and forming the hollow by joining each wall plate so that the interior surface of each wall plate faces each other.

A duct manufacturing method according to a ninth aspect of the present invention in which a hollow is formed by joining a plurality of flat wall plates, comprising the steps of: forming a strip-shaped folded portion by folding each wall plate in the interior surface thereof; and forming the hollow by joining each wall plate so that the interior surface of each wall plate faces each other.

A duct manufacturing method according to a tenth aspect of the present invention, in the duct manufacturing method according to the ninth aspect, wherein: in each of the wall plates which face each other, the folded portion is formed in the directions where the hollow is formed; and the wall plates are reinforced by connecting each folded portion using a reinforcing member.

A duct manufacturing method according to an eleventh aspect of the present invention, in the duct manufacturing method according to the eighth or ninth aspect, wherein the folded portion is formed by folding each wall plate after bending each wall plate in a substantially V-shape or in a substantially reverse V-shape so that the base-end parts thereof extend vertically.

According to the first aspect and the eighth aspect of the present invention, the reinforcing portion formed by the folded portion is provided outside of the duct. Therefore, the wall plates are reinforced with this reinforcing portion, so that the duct can be reinforced.

According to the second aspect and the ninth aspect of the present invention, the reinforcing portion formed by the folded portion is provided inside of the duct. Therefore, the wall plates are reinforced with this reinforcing portion, so that the duct can be reinforced.

According to the third aspect of the present invention, the folded portion is formed in the directions (i.e., the longitudinal directions of the duct) where the hollow is formed, or in the directions (i.e., the lateral directions of the duct) which intersect such directions. Therefore, the wall plate can be easily wrought to form the folded portion, and simultaneously, the duct can be reinforced in the longitudinal and lateral directions.

According to the fourth aspect of the present invention, each folded portion is connected by means of the connecting metal fitting, and the reinforcing portion is provided over the duct's full exterior circumference or full interior circumference. This helps make the duct stronger.

According to the fifth aspect of the present invention, in each of the wall plates which face each other, the folded portion is formed in the directions where the hollow is formed. Therefore, the duct's strength and rigidity becomes greater against a force (i.e., a bending moment) in the directions which intersect the directions where the hollow is formed.

According to the sixth aspect and the tenth aspect of the present invention, the folded portions are connected by means of the reinforcing member. Therefore, the wall plates which face each other are connected so that the wall plates can be reinforced. In other words, the entire duct can be reinforced.

In addition, according to these aspects of the present invention, there is no need to attach a reinforcing material such as an angle steel.

According to the seventh aspect of the present invention, a packing is provided so as to be sandwiched in the folded portion. Therefore, even if a bolt insertion hole or the like is formed in the folded portion, the air or the like inside of the hollow can be prevented from leaking outside.

According to the eleventh aspect of the present invention, the wall plate is bent in a substantially V-shape or in a substantially reverse V-shape so that its base-end parts extend vertically. Therefore, when it is folded, the base-end parts can be hindered from spreading. This makes it possible to form the folded portion whose base-end parts touch closely (or stick together).

### BRIEF DESCRIPTION OF DRAWINGS

FIG. 1 is a perspective view of a duct according to a first embodiment of the present invention.

FIG. 2 is a perspective view of a wall plate of FIG. 1.

FIG. 3a is a partly enlarged perspective view of a folded portion, showing the part of a dashed-circle mark in FIG. 2. FIG. 3b is a sectional view of the folded portion, showing a I-I section of FIG. 3a.

FIG. 4 is a perspective view of another wall plate of FIG. 1.

FIG. 5a is a partly enlarged perspective view of a junction portion, showing the part of a dashed-circle mark in FIG. 4. FIG. 5b is a sectional view of the junction portion showing its junction.

FIG. 6 is a perspective view of a corner metal fitting, showing its attachment.

FIG. 7 is a perspective view of a connecting metal fitting, showing its attachment.

FIG. 8 is a sectional view of the folded portion, showing a II-II section of FIG. 7.

FIG. 9 is a perspective view of a duct according to a second embodiment of the present invention.

FIG. 10 is a perspective view of a connecting metal fitting according to the second embodiment, showing its attachment.

FIG. 11a is a perspective view of a folded portion according to a third embodiment of the present invention. FIG. 11b is a sectional view of the folded portion, showing a III-III section of FIG. 11a.

FIG. 12 is a perspective view of a duct according to a forth embodiment of the present invention.

FIG. 13 is a front view of the duct of FIG. 12.

FIG. 14 is a plan view of the duct of FIG. 12, showing a state where a slit is formed in a process of forming its wall plate with a folded portion.

FIG. 15a is a plan view of the duct, showing a state where the folded portion is formed by folding the wall plate which follows the state of FIG. 14. FIG. 15b is a front view of the duct, showing the same state.

FIG. 16a is a plan view of the duct, showing a state where the end part of the folded portion is bent and laid down which follows the state of FIG. 15. FIG. 16b is a front view of the duct, showing the same state.

FIG. 17a is a plan view of the duct, showing a state where a bent portion is formed by bending the wall plate which follows the state of FIG. 16. FIG. 17b is a front view of the duct, showing the same state.

FIG. 18 is an enlarged front view of the duct of FIG. 12, showing the junction of the folded portion and a reinforcing bar.

FIG. 19 is a right side view (or partly sectional view) of the duct, showing the junction of FIG. 18.

FIG. 20 is a schematic front view of the duct according to the forth embodiment, showing two pairs of folded portions and reinforcing bars provided therein.

FIG. 21 is an enlarged front view of a folded portion according to a fifth embodiment of the present invention.

FIG. 22 is an enlarged front view of the folded portion of FIG. 21, showing a first step in its formation method.

FIG. 23 is an enlarged front view of the folded portion of FIG. 21, showing a second step in the formation method.

FIG. 24 is a perspective view of another connecting metal fitting.

FIG. 25a is a plan view of an L-shaped duct, showing an example thereof. FIG. 25b is a partly front view of this duct.

FIG. 25c is a partly left side view of the duct.

FIG. 26 is a perspective view of a conventional duct.

FIG. 27 is a perspective view of the conventional duct, showing the attachment of a reinforcing material thereto.

FIG. 28a is a sectional view of the reinforcing material and an iron plate, showing their junction by means of a rivet before the rivet is driven. FIG. 28b is a sectional view thereof, showing the rivet is driven. FIG. 28c is a sectional view thereof, showing the rivet is caulked.

### DETAILED DESCRIPTION OF THE INVENTION

Next, a duct according to each embodiment of the present invention will be described in detail with reference to the attached drawings.

### First Embodiment

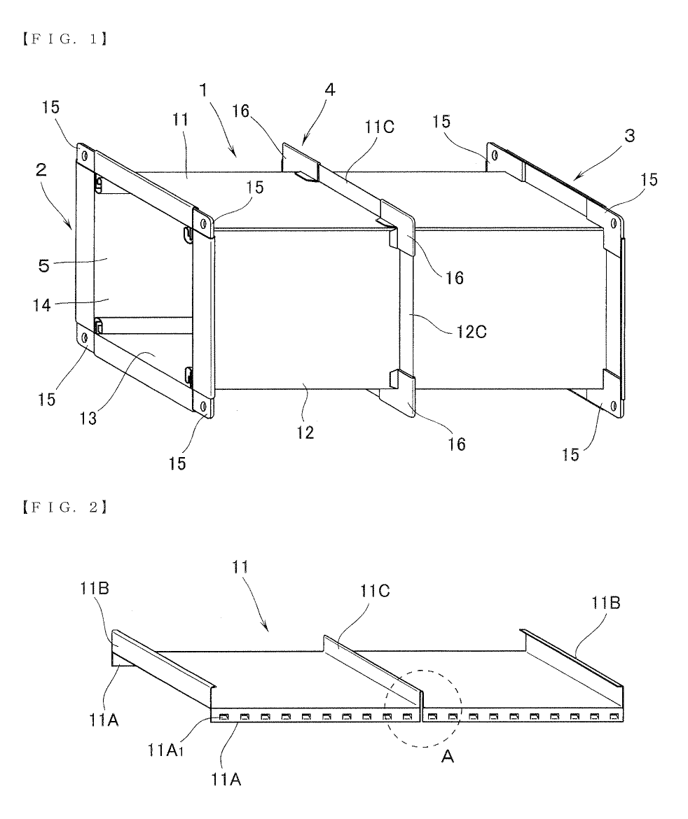

FIG. 1 is a perspective view of a duct according to a first embodiment of the present invention. A plurality of such ducts are joined and used on the inside of a structure, for example, inside of the ceiling of a building. The duct of FIG. 1 is configured by a duct body 1, junction flanges 2 and 3, and a reinforcing portion 4. The duct body 1 is shaped like a box which has a hollow 5 to send air or the like through. The duct body 1 is formed by four wall plates 11 to 14. The wall plates 11 to 14 are made of a steel plate, a galvanized iron plate or the like.

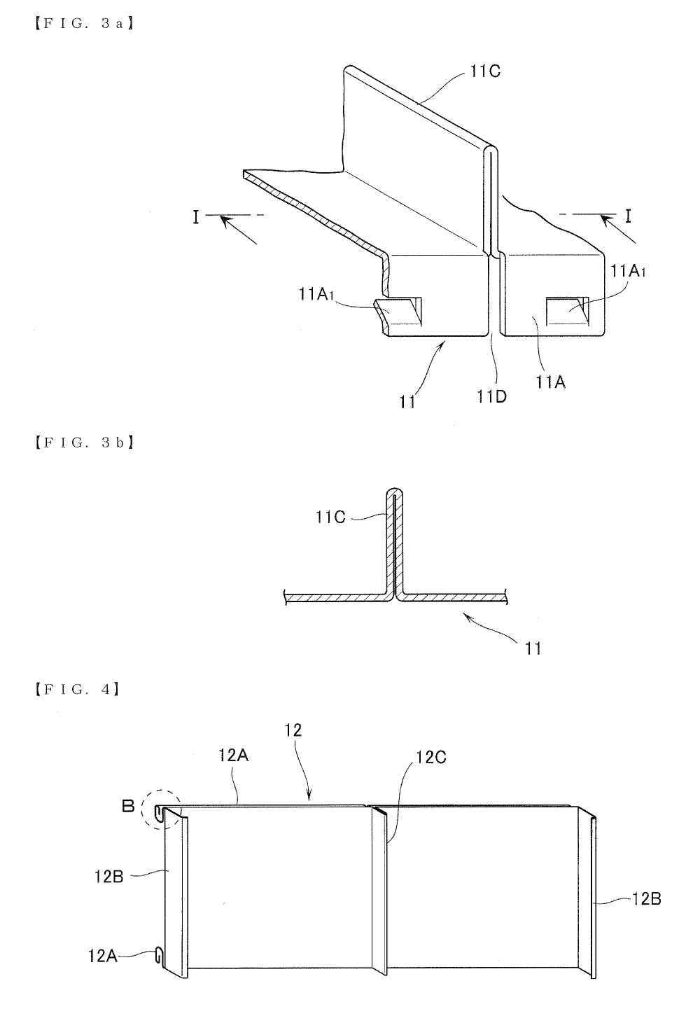

As shown in FIG. 2, both long-side edges of the wall plate 11 are each folded (hemmed) to form a junction portion 11A. Each junction portion 11A is formed with a plurality of single folds (hemming) 11A₁ for junction and makes up a button-punch-snap fold (hemming) together with a double fold (hemming) 12A (described later). In FIG. 2, a single fold on behalf of them is given a reference symbol 11A₁. This single fold 11A₁ is formed by cutting each junction portion 11A in a U-shape and bending this U-shaped cut part to the inside. The edge of each bent portion 11B is bent at a right angle. In the wall plate 11, a folded portion 11C is formed parallel to the bent portions 11B of the wall plate 11 or the short sides thereof and in the middle of the wall plate 11, as well as in the same direction as the direction in which the bent portions 11B stand up. As shown in FIG. 3a which is an enlarged view of the part of a dashed-circle mark in FIG. 2, the folded portion 11C is formed so as to bend in the middle of the wall plate 11 and protrude from the wall plate 11s surface. In other words, as shown in FIG. 3b, the folded portion 11C is shaped like a strip by folding the wall plate 11 and is united with the wall plate 11. Since the folded portion 11C is formed by bending the wall plate 11, the junction portions 11A each have a notch 11D in which each junction portion 11A is not formed, which has a width equal to the thickness of the folded portion 11C.

The wall plate 11 is wrought in this way. In this embodiment, the folded portion 11C of the wall plate 11 is formed, thereafter, the junction portions 11A are formed, and lastly, the bent portions 11B are formed. The wall plate 13 is the same as the wall plate 11.

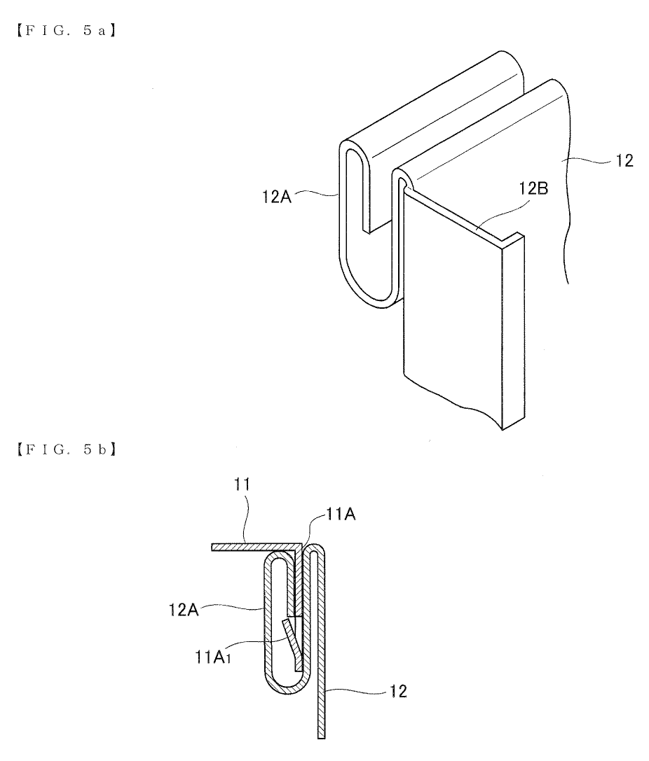

The wall plate 12 is wrought as follows. As shown in FIG. 4, both long-side edges of the wall plate 12 are each folded (hemmed) to form the double fold (hemming) 12A. Specifically, each double fold 12A is shaped so as to fit with its corresponding junction portion 11A of the wall plate 11. As shown in FIG. 5a which is an enlarged view of the part of a dashed-circle mark in FIG. 4, it is formed so that an edge of the wall plate 12 is bent inward on the side of the wall plate 12. Then, as shown in FIG. 5b, each double fold 12A of the wall plate 12 is combined in each junction portion 11A of the wall plate 11. Thereby, the wall plate 11 and the wall plate 12 are joined together. In the same way as the wall plate 11, both short-side edges of the wall plate 12 are bent to form bent portions 12B. Further, in the wall plate 12, similarly to the wall plate 11, a folded portion 12C is formed parallel to the bent portions 12B of the wall plate 12 or the short sides thereof and in the middle of the wall plate 12, as well as in the same direction as the direction in which the bent portions 12B stand up. The folded portion 12C is formed so as to bend in the middle of the wall plate 12 and protrude from the wall plate 12's surface. In other words, in the same way as the folded portion 11C, the folded portion 12C is shaped like a strip by folding the wall plate 12 and is united with the wall plate 12.

The wall plate 12 is wrought in this way. In this embodiment, similarly to the wall plate 11, the folded portion 12C of the wall plate 12 is formed, thereafter, the double folds 12A are formed, and lastly, the bent portions 12B are formed. The wall plate 14 is the same as the wall plate 12.

The wall plates 11 to 14 wrought in the above described manner are disposed so that the wall plate 12's interior surface and the wall plate 14's interior surface are disposed so as to separate from and face each other. Then, the junction portions of the wall plate 11 and the wall plate 13 are fitted into their corresponding junction portions of the wall plate 12 and the wall plate 14 (see FIG. 5), so that the wall plate 11's interior surface and the wall plate 13's interior surface face each other. Thereby, the wall plates 11 to 14 are joined up to form a box body made up of the wall plates 11 to 14. After this, as shown in FIG. 6, for example, in order to connect inter-end parts formed between an end of each bent portion 11B of the wall plate 11 and its corresponding end of each bent portion 12B of the wall plate 12, an L-shaped corner metal fitting 15 is attached to the bent portion 11B's end part and the bent portion 12B's end part. Likewise to the other inter-end parts, the corner metal fittings 15 are attached to form the junction flange 2 and the junction flange 3. The junction flange 2 and the junction flange 3 are used for its connection to another duct.

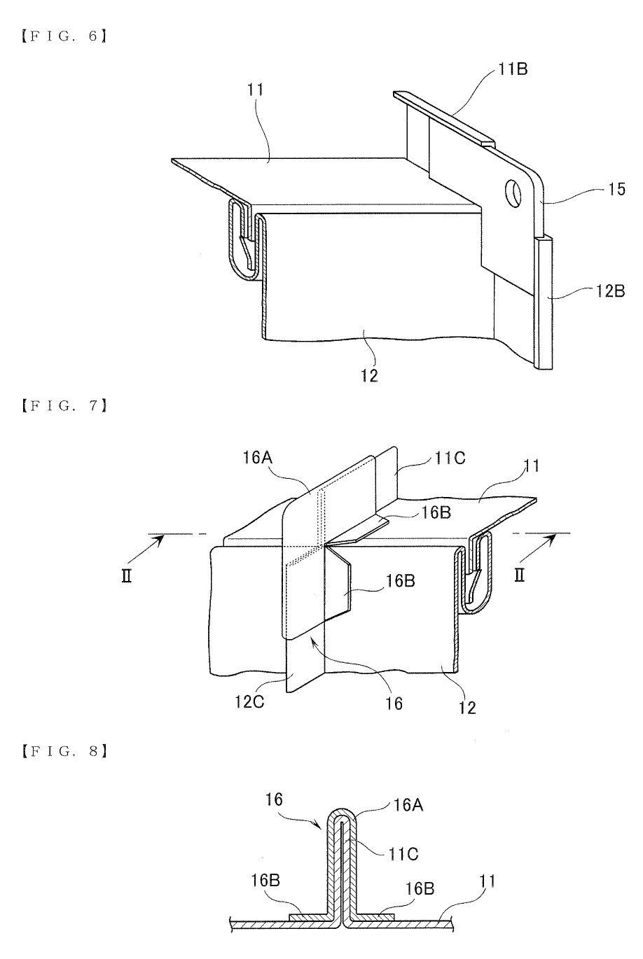

As shown in FIG. 7, for example, in order to connect inter-end parts formed between an end of the folded portion 11C of the wall plate 11 and its corresponding end of the folded portion 12C of the wall plate 12, an L-shaped connecting metal fitting 16 is attached to the folded portion 11C's end part and the folded portion 12C's end part. This connecting metal fitting 16 is formed, as shown in FIG. 8, by a main body 16A which has a U-shape in section to cover the folded portion 11C, and flanges 16B provided on both sides of the main body 16A. After the main body 16A is attached to the folded portions 11C and 12C, the flanges 16B is subjected to spot welding, so that the connecting metal fitting 16 is fixed on the wall plates 11 and 12. At this time, the connecting metal fitting 16 closes the notch 11D (see FIG. 3). To the other notch parts alike, the connecting metal fittings 16 are attached, and thus, the reinforcing portion 4 is formed in the directions which intersect the directions (air flow direction) where the hollow 5 is formed.

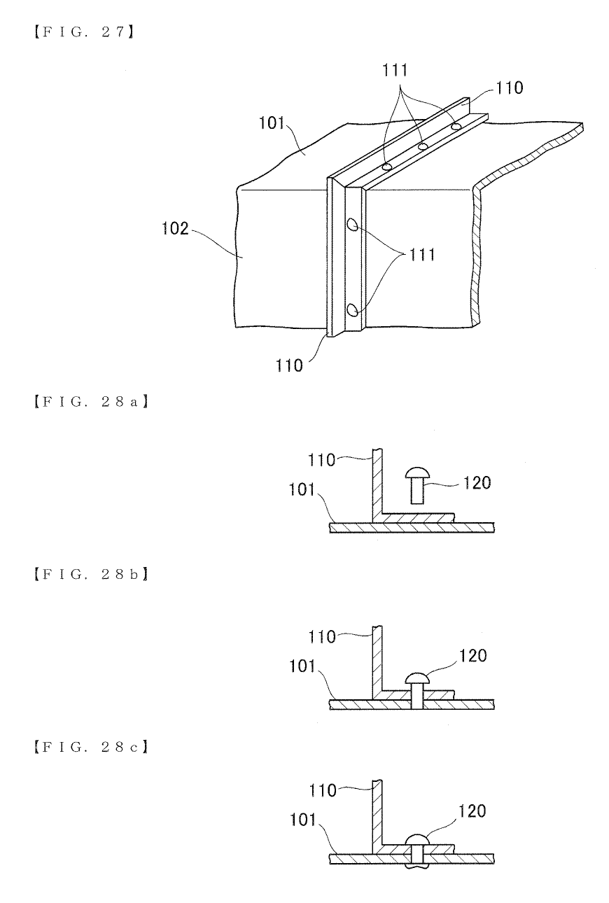

Each of the folded portions which include the folded portions 11C and 12C of the wall plates 11 to 14 is equivalent to a conventional reinforcing material (see FIG. 26). Specifically, each folded portion of the wall plates 11 to 14 is provided so as to protrude at a right angle from its corresponding surface of the wall plates 11 to 14. This helps reinforce the flat wall plates 11 to 14. Besides, the parts between each end of the folded portions which include the folded portions 11C and 12C of the wall plates 11 to 14 are connected using the connecting metal fitting 16. Thereby, the reinforcing portion 4 is formed. This makes it possible to reinforce the flat wall plates 11 to 14 more significantly than any conventional one. In addition, the connecting metal fittings 16 close the four notches including the notch 11D (see FIG. 3). This contributes to keeping the duct airtight. Herein, the height of each folded portion including the folded portions 11C and 12C is set in accordance with the strength required for reinforcement. Specifically, the higher each folded portion becomes, the greater the reinforcement strength will be. Hence, the height of each folded portion is set so that a reinforcement strength suitable for the thickness, length and width of each wall plate 11 to 14 can be obtained.

As described above, according to this embodiment, because of the reinforcing portion 4 formed by bending the wall plates 11 to 14, there is no need for a conventional L-shaped reinforcing material. This makes it possible to drastically reduce the numbers of working processes and component parts in producing the duct, compared with those of any conventional one, as well as diminish the duct's weight. Furthermore, a conventionally-shaped reinforcing material is not required, so that a loud noise can be prevented from being produced by driving a rivet in a working process. Moreover, air can be kept from leaking due to a rivet, thus maintaining the airtightness of the duct securely.

### Second Embodiment

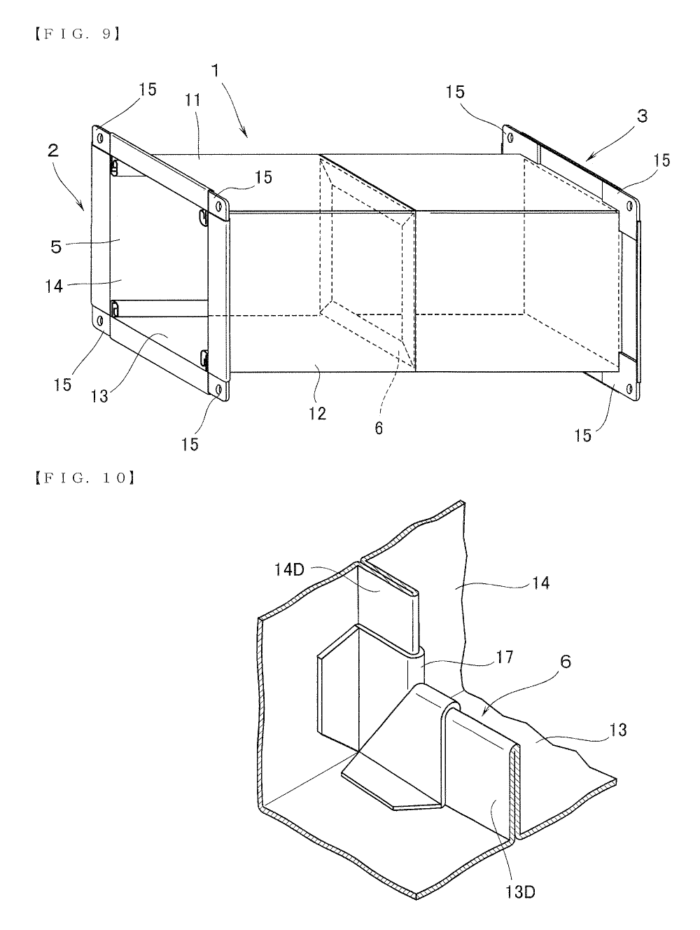

FIG. 9 shows a duct according to a second embodiment of the present invention. In each of the second to fifth embodiments, component elements are given the same reference characters and numerals as those of the above described first embodiment, as long as the former are identical to the latter. Thus, their description is omitted. In FIG. 9, the parts of the junction flange 2 and the junction flange 3 which are concealed from view are omitted. In this embodiment, a reinforcing portion 6 corresponding to the reinforcing portion 4 according to the first embodiment is provided in the hollow 5. Specifically, folded portions are formed so as to protrude from the interior surfaces of the wall plates 11 to 14 in the same was as the folded portions 11C and 12C according to the first embodiment. The folded portions of the wall plates 11 to 14 are formed in the direction opposite to the direction according to the first embodiment. For example, as shown in FIG. 10, a corner part is formed by an end of a folded portion 13D provided inside of the wall plate 13 and its corresponding end of a folded portion 14D of the wall plate 14. This corner part is covered with a connecting metal fitting 17 whose section is shaped like a U-letter. Thereby, a notch is closed which is produced in this junction portion and has a width equal to the thicknesses of the folded portion 13D and the folded portion 14D. To the other corner parts, the connecting metal fittings 17 are also attached to form the reinforcing portion 6. Incidentally, in FIG. 10, the junction of the wall plate 13 and the wall plate 14 is not shown.

In this embodiment, similarly to the first embodiment, each of the folded portions which include the folded portion 13D and the folded portion 14D provided in the wall plates 11 to 14 and in the hollow 5 is equivalent to a conventional reinforcing material. Specifically, the folded portions of the wall plates 11 to 14 are provided so as to protrude at a right angle inside of the hollow 5 from the wall plates 11 to 14. This helps reinforce the flat wall plates 11 to 14. Besides, the corner parts of each folded portion which includes the folded portions 13D and 14D of the wall plates 11 to 14 are connected using the connecting metal fitting 17. Thereby, the reinforcing portion 6 is formed. This makes it possible to reinforce the flat wall plates 11 to 14 more significantly than any conventional one. In addition, the connecting metal fittings 17 close the notch in each corner, so that the duct can be kept airtight.

### Third Embodiment

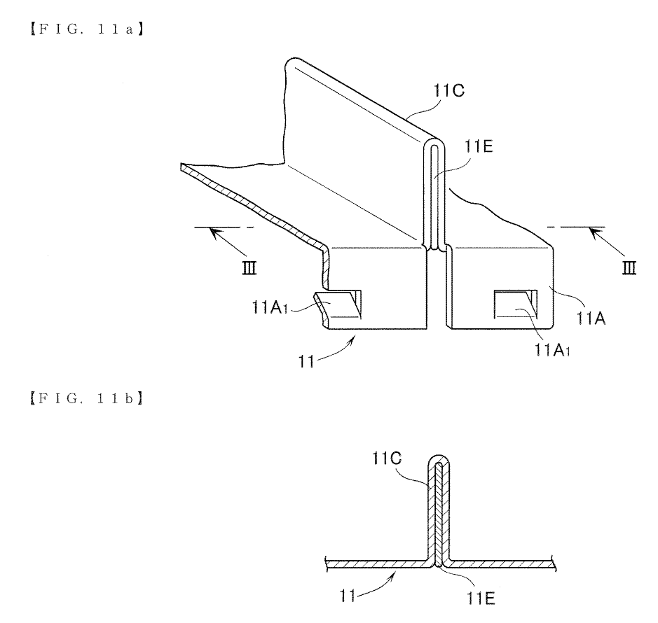

In a third embodiment of the present invention, the reinforcing portions according to the first embodiment and the second embodiment areas follows. For example, in the folded portion 11C of the wall plate 11 (see FIG. 3), as shown in FIG. 11a, when the wall plate 11 is bent in its middle, a flat reinforcing plate 11E is inserted into the wall plate 11. Specifically, as shown in FIG. 11b, the reinforcing plate 11E is attached so as to be positioned inside of the folded portion 11C and be closely united to the folded portion 11C. This makes it possible to strengthen the folded portion 11C further. For example, in order to obtain a necessary reinforcement strength using only the folded portion 11C, the folded portion 11C needs to be heightened. In such a case, a required reinforcement strength can be obtained while its height is kept low.

### Fourth Embodiment

In a fourth embodiment of the present invention, a folded portion (i.e., a reinforcing portion) is formed in the air flow directions (i.e., the longitudinal directions or axial-line directions of the duct) where the hollow 5 is formed. Specifically, as shown in FIG. 12, in each of the wall plate 11 and the wall plate 13 which face each other, folded portions 11F and 13F which protrude from their interior surfaces are formed in the hollow 5's formation directions.

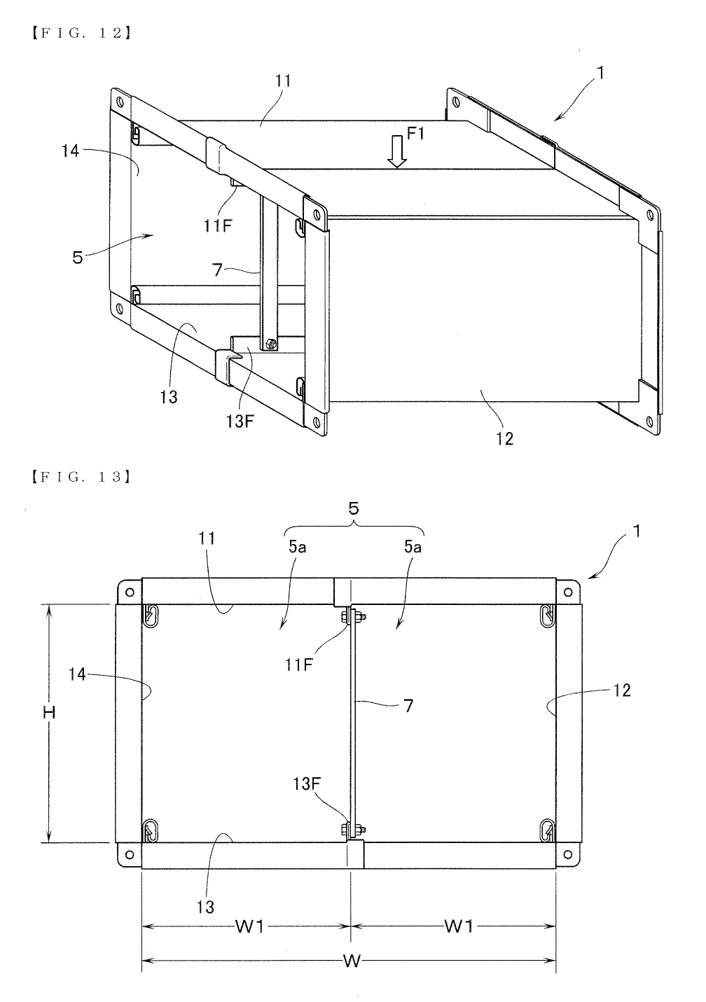

In this embodiment, the hollow 5 of the duct body 1 is shaped, as shown in FIG. 13, like a rectangle in section whose lateral side is longer. Hence, a width W of the wall plates 11 and 13 located up and down is greater than a width (or height) H of the wall plates 12 and 14 located right and left. In other words, as shown in the figure, in the case where the wall plates 11 and 13 are horizontally positioned to form the duct body 1, the duct body 1's rigidity (i.e., moment of inertia of area) is lower than the case where it is vertically positioned. In order to enhance the duct body 1's strength and rigidity, the folded portions 11F and 13F are formed, and further, the folded portions 11F and 13F are linked together by means of a reinforcing bar (i.e., the reinforcing member) 7.

The folded portions 11F and 13F are each formed, as follows, in the middle part of the wall plates 11 and 13. Herein, the folded portion 13F will be described as an example thereof.

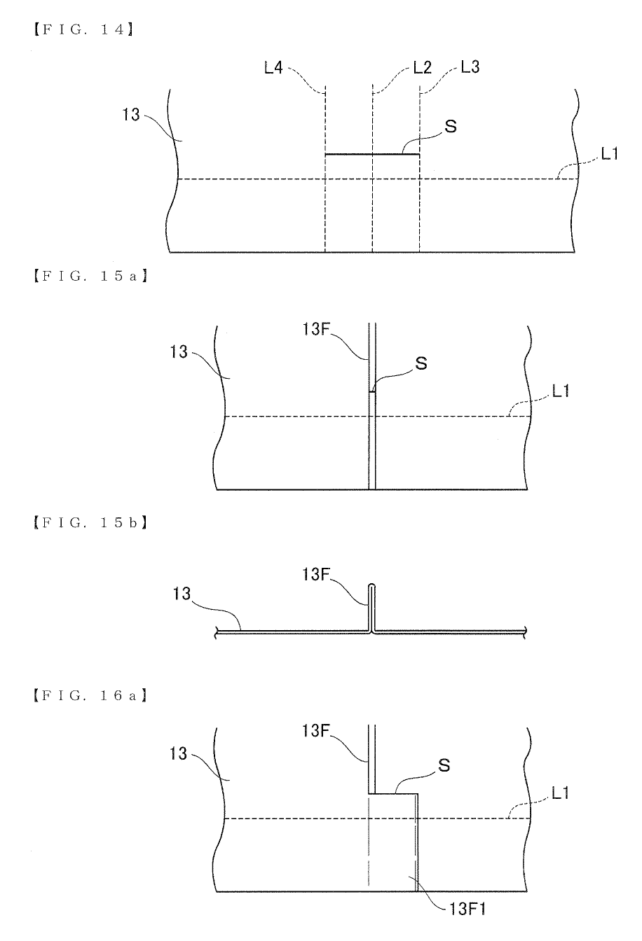

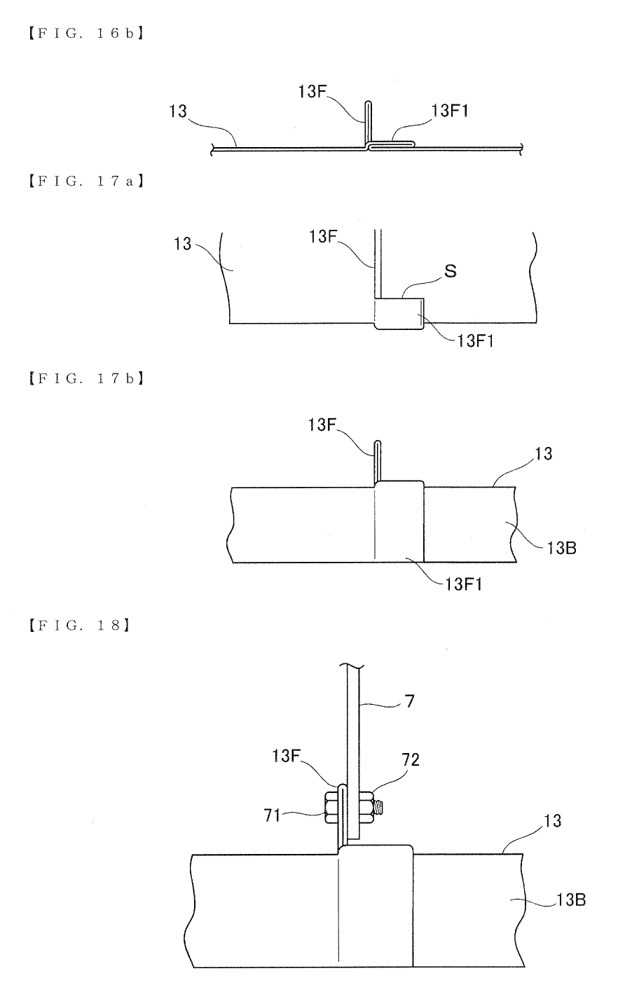

First, in FIG. 14, a line L1 is a bending line for forming a bent portion 13B, and lines L2 to L4 are bending lines for forming the folded portion 13F. Then, slightly inside (on the side opposite to its edge) from the line L1, a slit (i.e., a cut line) S parallel to the line L1 is formed from the line L3 to the line L4. Next, as shown in FIG. 15, the wall plate 13 is folded (or bent and raised) along the lines L2 to L4, so that the folded portion 13F is formed. Sequentially, as shown in FIG. 16, an end part 13F1 of the folded portion 13F is bent and laid down along the slit S. Then, as shown in FIG. 17, the wall plate 13 is bent along the line L1 to form the bent portion 13B. If the folded portion 13F and the bent portion 13B are formed in such a manner, there is no need to cut off (or cut down) a part of the wall plate 13. This makes it possible to improve the stock utilization, and at the same time, form it easily using a conventional folding machine or the like because it can be wrought by the common-plate method which has been used generally.

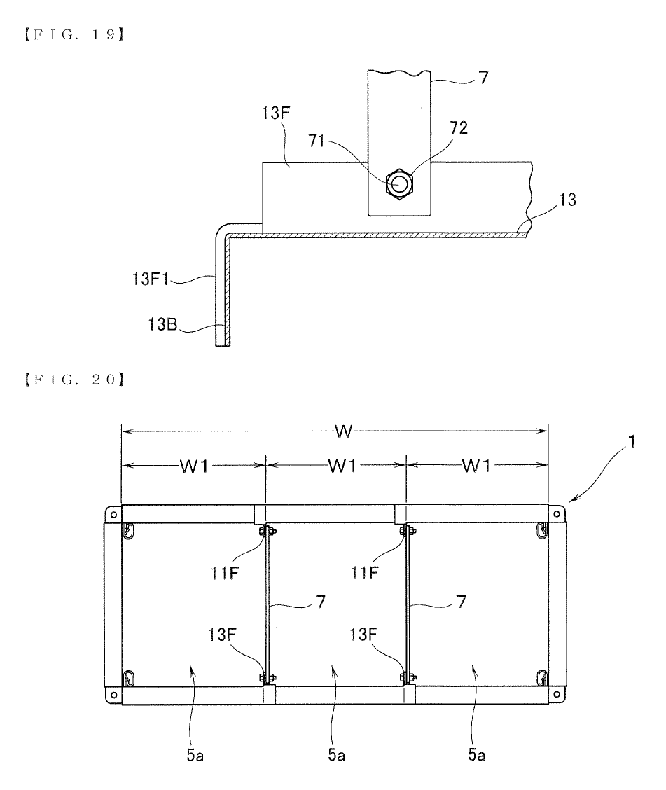

The reinforcing bar 7 is a long (and narrow) metal plate, and its width, thickness and material are designed to have a strength necessary for reinforcing the duct body 1. As shown in FIGS. 18 and 19, a bolt 71 is inserted into bolt insertion holes (not shown) formed in each end part of the reinforcing bar 7 and the folded portion 13F. Then, a nut 72 is screwed onto the bolt 71, so that the folded portion 11F and 13F are connected via the reinforcing bar 7. In this embodiment, two such reinforcing bars 7 are provided in the depth directions of the hollow 5. However, the number of such bars is set in accordance with the size of the duct body 1, the strength necessary for its reinforcement, or the like.

According to the above described configuration, in each of the wall plate 11 and the wall plate 13 which face each other, the folded portions 11F and 13F are formed in the hollow 5's formation directions. Therefore, the duct body 1's strength and rigidity become greater against a force F1 (i.e., a bending moment) in the directions which intersect the hollow 5's formation directions. Besides, the folded portions 11F and 13F are linked together by means of the reinforcing bar 7, and thereby, the wall plates 11 and 13 are connected and reinforced. This helps reinforce the whole duct.

In this way, the entire duct is reinforced, so that each plate of the duct body 1 can be thinned. In other words, in the case where the duct body 1's plate thickness is prescribed in accordance with the width W of the duct body 1, even if the width W is great, the wall plates 11 to 14 which are thin can be used.

For example, let's assume that the plate thickness may be 0.5 mm if the width W is 450 mm or below, and the plate thickness has to be more than 0.5 mm if the width W exceeds 450 mm. At this time, if the width W is beyond 450 mm and is equal to, or less than, 900 mm, then a pair of such folded portions 11F and 13F is formed in the width's middle. Then, they are connected using the reinforcing bar 7. Thereby, a width W1 (see FIG. 13) of each division hollow 5a becomes 450 mm or below which is formed by partitioning it with the folded portions 11F and 13F and the reinforcing bar 7. Thus, the duct body 1's plate thickness can be set to 0.5 mm. In other words, the folded portions 11F and 13F and the reinforcing bar 7 make it possible to consider this in respect of its strength as if two ducts are connected to each other in the width directions.

Similarly, if the duct body 1's width W is beyond 900 mm and is equal to, or less than, 1350 mm, then as shown in FIG. 20, two pairs of such folded portions 11F and 13F are formed at even intervals. Then, they are connected together using the reinforcing bar 7. Thereby, three ducts may be regarded as being connected to each other in the width directions, so that the duct body 1's plate thickness can be set to 0.5 mm. Further in the same way, if the duct body 1's width W is greater than the above, then several pairs of such folded portions 11F and 13F are formed so that the width W1 of each division hollow 5a becomes 450 mm or below. Then, those are connected together using the reinforcing bar 7, and thus, the duct body 1's plate thickness can be set to 0.5 mm.

### Fifth Embodiment

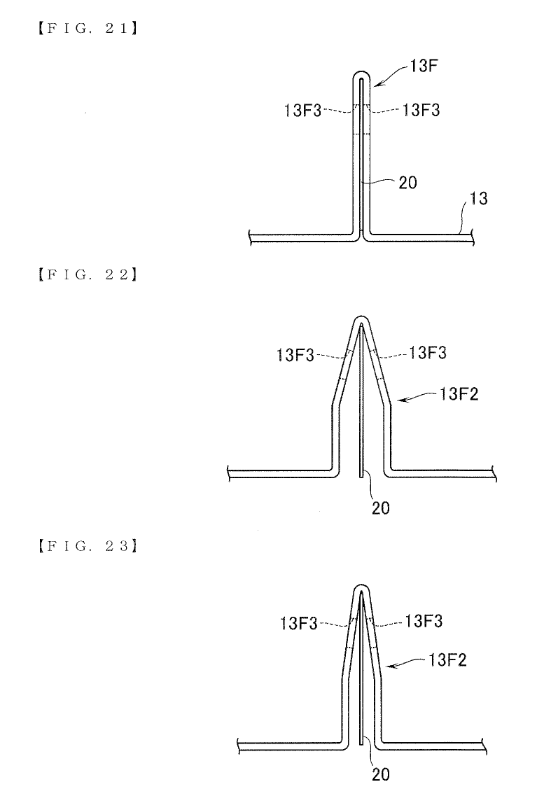

FIG. 21 is an enlarged front view of the folded portion 13F according to a fifth embodiment of the present invention. In this embodiment, a packing 20 is provided so as to be sandwiched in the folded portion 13F according to the forth embodiment. This packing 20 is made of a flame-retardant material, is shaped like a sheet and has a substantially identical shape with the joined surfaces of the folded portion 13F. In other words, it is sandwiched in almost over the whole joined surfaces.

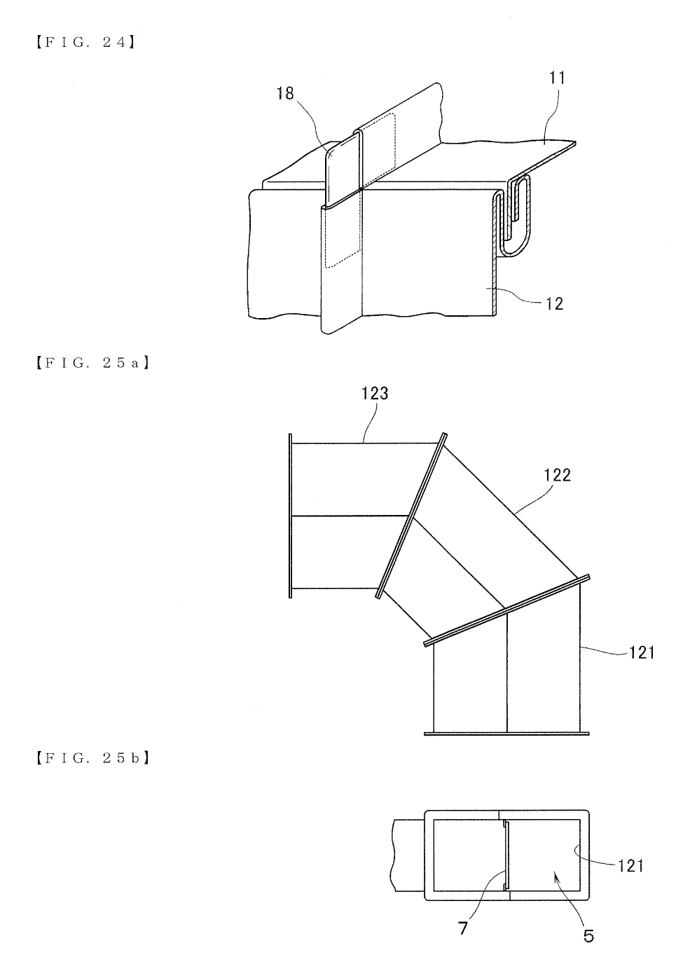

Such a packing 20 is provided in the folded portion 13F, as follows. First, as shown in FIG. 22, the wall plate 13 is bent in a substantially reverse V-shape so that its base-end parts (or root part) extend vertically. Herein, this shape becomes a reverse V-shape 13F2. After this, with the packing 20 located between the reverse V-shape 13F2, as shown in FIG. 23, the reverse V-shape 13F2 is folded so that its opening width becomes smaller. As a result, the folded portion 13F is formed. Thereby, the packing 20 is sandwiched in the folded portion 13F. Then, after the packing 20 is disposed, in the position which corresponds to bolt insertion holes 13F3 for inserting the bolt 71 which are formed in the folded portion 13F, a bolt insertion hole is formed in the packing 20.

In this way, the packing 20 is sandwiched in the folded portion 13F. Therefore, even if the bolt insertion holes 13F3 are formed in the folded portion 13F, the air or the like inside of the hollow 5 can be prevented from leaking out through the bolt insertion holes 13F3 from a crevice (i.e., a gap between the plates put together) in the folded portion 13F. Hence, in order to prevent a leak of the air or the like, there is no need to seal up the vicinity of the bolt insertion holes 13F3, or take another such measure. In addition, when the folded portion 13F is formed, the wall plate 13 is bent in a substantially reverse V-shape so that its base-end parts extend vertically. Therefore, when it is folded, the base-end parts can be hindered from spreading, thereby keeping the folded portion 13F touching closely (or sticking fast) to the packing 20.

Herein, the folded portion 13F is described, but in the same way, the folded portion 11F is also provided with the packing 20. In this case, the wall plate 11 is bent in a substantially V-shape so that its base-end parts extend vertically. Thereafter, it is folded so that the packing 20 is sandwiched therein, and thus, the folded portion 11F is formed.

Hereinbefore, the first to fifth embodiments of the present invention are described in detail. However, concrete configurations thereof are not limited to each embodiment. Therefore, unless changes and modifications in design depart from the scope of the present invention, they should be construed as being included therein. For example, in the first to third embodiments, such a connecting metal fitting is designed to cover such a folded portion. However, as shown in FIG. 24, for example, an L-shaped connecting metal fitting 18 may also be provided inside of the folded portion 11C of the wall plate 11 and the folded portion 12C of the wall plate 12. Furthermore, in the first to third embodiments, the folded portions 11C, 12C, 13C and 14C are formed (in the shape of a ring) in the same position of all the wall plates 11 to 14. However, such folded portions may be formed only in some of the wall plates 11 to 14, or such folded portions can also be formed in different positions.

Moreover, in each embodiment, the duct has a rectangular sectional shape. However, the duct's sectional shape is not limited to this. Besides, the place where such a reinforcing portion is formed in a single such duct is not limited to one place, either.

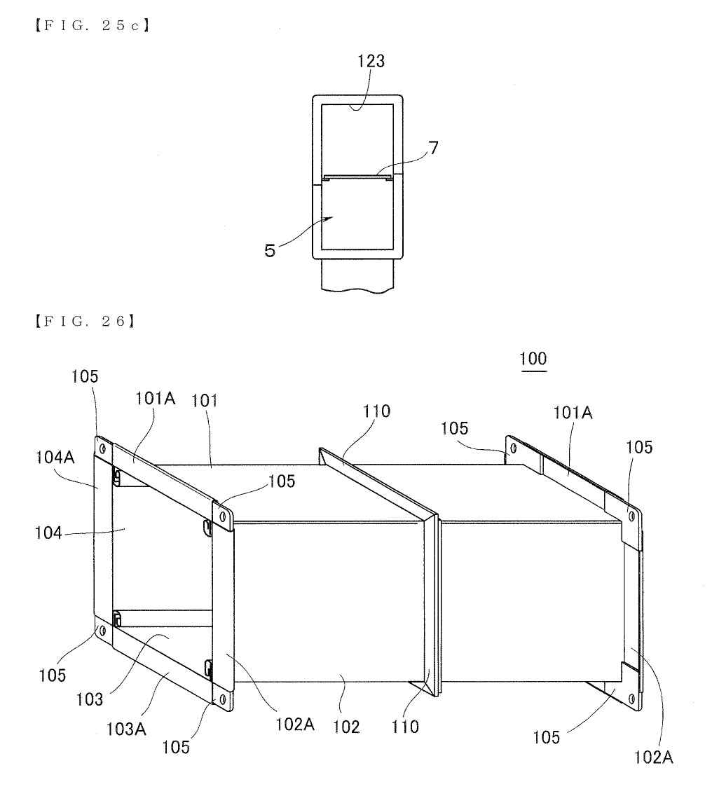

In addition, in each embodiment, such a straight duct is provided whose axial line extends straight, but another type of duct may also be used. For example, as shown in FIGS. 25a to 25c, an L-shaped duct can be applied. This duct shown in the figures is configured by connecting three duct bodies 121 to 123 while changing their connection directions (i.e., axial directions). In the same way as the fourth embodiment, such folded portions are formed in the formation directions (i.e., axial directions) of the hollow 5 of each duct body 121 to 123. Then, opposite (mutual faced) such folded portions are connected via the reinforcing bar 7. Hence, the present invention can also be applied to a duct other than a straight duct. Besides, the fourth embodiment, the reinforcing member is the long reinforcing bar 7, but depending upon the size, strength necessary for reinforcement or the like of the duct body 1, it may also be a flat metal plate which extends in the depth directions of the hollow 5.

What is claimed is:

1. A duct which has a hollow formed by joining a plurality of flat wall plates so that the interior surfaces of the wall plates face each other,
wherein each of the wall plates includes a strip-shaped folded portion formed by folding each wall plate on the side of the exterior surface thereof.

2. A duct which has a hollow formed by joining a plurality of flat wall plates so that the interior surfaces of the wall plates face each other,
wherein each of the wall plates includes a strip-shaped folded portion formed by folding each wall plate on the side of the interior surface thereof.

3. The image formation apparatus according to claim 1 or 2, wherein the folded portion is formed in the directions where the hollow is formed, or in the directions which intersect the directions where the hollow is formed.

4. The image formation apparatus according to claim 3, wherein: the folded portion in each wall plate is formed in the directions which intersect the directions where the hollow is formed; and a connecting metal fitting is provided which connects an end of each folded portion and the end of the folded portion adjacent to this end.

5. The image formation apparatus according to claim 2, wherein in each of the wall plates which face each other, the folded portion is formed in the directions where the hollow is formed.

6. The image formation apparatus according to claim 5, wherein a reinforcing member is provided which reinforces the wall plates by connecting each folded portion.

7. The image formation apparatus according to claim 1 or 2, wherein a packing is provided so as to be sandwiched in the folded portion.

8. A duct manufacturing method in which a hollow is formed by joining a plurality of flat wall plates, comprising the steps of:
forming a strip-shaped folded portion by folding each wall plate in the exterior surface thereof; and
forming the hollow by joining each wall plate so that the interior surface of each wall plate faces each other.

9. A duct manufacturing method in which a hollow is formed by joining a plurality of flat wall plates, comprising the steps of:
forming a strip-shaped folded portion by folding each wall plate in the interior surface thereof; and
forming the hollow by joining each wall plate so that the interior surface of each wall plate faces each other.

10. The duct manufacturing method according to claim 9, wherein:
in each of the wall plates which face each other, the folded portion is formed in the directions where the hollow is formed; and
the wall plates are reinforced by connecting each folded portion using a reinforcing member.

11. The duct manufacturing method according to claim 8 or 9, wherein the folded portion is formed by folding each wall plate after bending each wall plate in a substantially V-shape or in a substantially reverse V-shape so that the base-end parts thereof extend vertically.
